(19) United States
(12) Patent Application Publication
(10) Pub. No.: US 2019/0329537 A1
(43) Pub. Date: Oct. 31, 2019

(54) THERMOPLASTIC RESIN FILM AND ADHESIVE LABEL

(71) Applicant: YUPO CORPORATION, Tokyo (JP)

(72) Inventor: Takahiro ZAMA, Ibaraki (JP)

(73) Assignee: YUPO CORPORATION, Tokyo (JP)

(21) Appl. No.: 16/479,026

(22) PCT Filed: Jan. 29, 2018
(86) PCT No.: PCT/JP2018/002762

§ 371 Date: Jul. 18, 2019

(30) Foreign Application Priority Data
Jan. 30, 2017 (JP) 2017-014138

(51) Int. Cl. B32B 27/32; C09J 123/06; C09J 7/20; G09F 3/02; C09J 7/24

(52) U.S. Cl. CPC B32B 27/32; C09J 123/06; C09J 7/201; G09F 3/02; C09J 7/243; B32B 2250/02; B32B 2519/00; B32B 2264/0228; B32B 2307/412; B32B 2323/10; B32B 2323/04; B32B 2398/00; B32B 2255/10

(57) ABSTRACT

Provided are a thermoplastic resin film and an adhesive label including the thermoplastic resin film as a substrate excellent not only in transparency but also in indication visibility. The thermoplastic resin film of the present invention includes, in the following order, a printable layer (II), a substrate layer (I) and an adhesive-processing layer (III), wherein the substrate layer (I) comprises 60 to 99.5% by mass of a crystalline polypropylene resin and 0.5 to 40% by mass of a petroleum resin, and an internal haze of the thermoplastic resin film is less than 15%.

### TECHNICAL FIELD

The present invention relates to a thermoplastic resin film and an adhesive label including the thermoplastic resin film.

### BACKGROUND ART

Heretofore, as indication labels for packaging or clothing, flexible papers, resin films containing fillers, transparent films and the like have been used as a substrate. For example, resin films comprising a polyethylene resin as a main component and containing titanium oxide as a filler have been proposed as white opaque label films (for example, Patent Literature 1). Highly transparent label film comprising a low-density polyethylene resin as a main component and having a haze and gloss adjusted to specific ranges also have been proposed (for example, Patent Literature 2).

### CITATION LIST

### Patent Literatures

Patent Literature 1: Japanese Patent Laid-Open No. 6-102826
Patent Literature 2: Japanese Patent Laid-Open No. 6-73345

### SUMMARY OF INVENTION

### Technical Problem

However, as a result of investigation by the present inventor, it has been found that a label including a paper substrate or a resin film containing a filler as a substrate has good visibility of an indication such as characters but a hue, a fabric pattern, a texture or the like of an adherend cannot be seen through at the time of affixing the label to the adherend and the appearance of a commercial product which is the adherend is therefore liable to be impaired. On the other hand, it has been found that a label including a highly transparent film is low in visibility of the indication intended by the label.

An object of the present invention is to provide a thermoplastic resin film excellent not only in transparency but also in indication visibility. Another object of the present invention is to provide an adhesive label including the thermoplastic resin film as a substrate.

### Solution to Problem

The present inventor has made intensive studies to solve the above-mentioned problems. As a result, the present inventor has found that the above problems can be solved by using a resin film comprising a crystalline polypropylene resin as a substrate, compounding a petroleum resin into the resin film and further providing an adhesive-processing layer for the resin film.

Accordingly, the present invention summarized as follows.

[1] A thermoplastic resin film comprising, in the following order, a printable layer (II), a substrate layer (I) and an adhesive-processing layer (III), wherein the substrate layer (I) comprises 60 to 99.5% by mass of a crystalline polypropylene resin and 0.5 to 40% by mass of a petroleum resin, and an internal haze of the thermoplastic resin film is less than 15%.

[2] The thermoplastic resin film according to [1], wherein the adhesive-processing layer (III) comprises 50% by mass or more of a linear low-density polyethylene resin.

[3] The thermoplastic resin film according to [1] or [2], wherein the substrate layer (I) further comprises a nucleating agent.

[4] The thermoplastic resin film according to any one of [1] to [3], wherein the printable layer (II) comprises a polypropylene resin and a polyethylene resin.

[5] The thermoplastic resin film according to any one of [1] to [4], wherein the substrate layer (I), the printable layer (II) and the adhesive-processing layer (III) each comprise an unstretched resin film.

[6] The thermoplastic resin film according to any one of [1] to [5], wherein the thickness of each of the printable layer (II) and the adhesive-processing layer (III) is 10 to 35% relative to 100% of the thickness of the substrate layer (I).

[7] The thermoplastic resin film according to any one of [1] to [6], wherein the surface on the adhesive-processing layer (III) side of the thermoplastic resin film has an arithmetic mean roughness (Ra) of 0.5 to 5 μm and a ten-point mean roughness (Rzjis) of 10 to 50 μm.

[8] The thermoplastic resin film according to any one of [1] to [7], wherein the surface on the printable layer (II) side of the thermoplastic resin film has an arithmetic mean roughness (Ra) of 0.15 to 2 pin and a ten-point mean roughness (Rzjis) of 0.5 to 6 μm.

[9] An adhesive label comprising, the thermoplastic resin film according to any one of [1] to [8], and an adhesive layer (IV) provided on the surface of the adhesive-processing layer (III) side of the thermoplastic resin film.

### Advantageous Effects of Invention

According to the present invention, it is possible to provide a thermoplastic resin film excellent in transparency. The hue or texture of an adherend can be seen through at the time of affixing the thermoplastic resin film to the adherend and the appearance of a commercial product which is the adherend therefore is not impaired. In addition, the thermoplastic resin film further has a mat feeling which makes it easy to recognize an indication such as printed characters, and is also excellent in visibility of the indication. Therefore, it is possible to provide a thermoplastic resin film excellent not only in transparency but also in indication visibility. Further, it is possible to provide an adhesive label excellent in transparency and indication visibility by using the thermoplastic resin film of the present invention as a substrate.

### DESCRIPTION OF EMBODIMENTS

A thermoplastic resin film of the present invention and an adhesive label including the thermoplastic resin film are described in more detail below. In the present specification, the numerical range expressed using “to” means a range including numerical values described before and after “to” as a lower limit value and an upper limit value.

### [Thermoplastic Resin Film]

A thermoplastic resin film of the present invention is a multilayer-laminated film having at least three layers comprising, in the following order, a printable layer (II), a substrate layer (I) and an adhesive-processing layer (III). The thermoplastic resin film of the present invention is also characterized by having an internal haze of less than 15%. The internal haze is preferably less than 12% and more preferably less than 10%. The thermoplastic resin film having a low internal haze is excellent in transparency. This makes it possible to see a texture, a picture or the like of an adherend through the thermoplastic resin film or the adhesive label, for example, when wrapping the adherend with the thermoplastic resin film and when affixing the film to the adherend as an adhesive label. As used herein, the internal haze means a haze inherent to a thermoplastic resin film itself. Specifically, the internal haze is a value obtained by subtracting the haze component derived from the irregularities of the surface from the haze of the entire layer measured throughout the thermoplastic resin film, and measured as described in Examples described later.

Hereinafter, the substrate layer (I), the printable layer (II) and the adhesive-processing layer (III) constituting the thermoplastic resin film will be described in detail.

### [Substrate Layer (I)]

The substrate layer (I) constituting the thermoplastic resin film of the present invention is a layer located between the printable layer (II) and the adhesive-processing layer (III) in the thermoplastic resin film. The substrate layer (I) is a layer at least including 60 to 99.5% by mass of a crystalline polypropylene resin as a thermoplastic resin and 0.5 to 40% by mass of a petroleum resin. The inclusion of the crystalline polypropylene resin and the petroleum resin makes it possible to obtain a flexible layer excellent in transparency with an internal haze of less than 15%. In addition, the inclusion of the petroleum resin makes it possible to increase the adhesion of the substrate layer (I) to each of the printable layer (II) and the adhesive-processing layer (III) and thereby increase the interlaminar strength.

Examples of the crystalline polypropylene resin that can be used in the present invention include a propylene homopolymer having isotactic or syndiotactic stereoregularity, and a copolymer of propylene as a main component with an α-olefin such as ethylene, butene, hexene, heptene, octene or 4-methylpentene-1. Each of these copolymers may be a dimer, trimer or tetramer and may be a random copolymer or block copolymer. Among them, an isotactic propylene homopolymer is preferable from the viewpoint of mechanical strength and film formability.

Examples of the petroleum resin that can be used in the present invention include higher unsaturated hydrocarbon compounds present in a high-temperature pyrolysis oil such as naphtha, for example, mainly a C5 or C9 fraction left after collecting necessary fractions from the pyrolysis oil. Specific examples of the petroleum resin include an unsaturated hydrocarbon resin obtained by polymerizing butadiene, piperylene, isoprene, dicyclopentadiene, terpene, styrene, methylstyrene, vinyltoluene, indene, methylindene, a mixture thereof, and the like as a raw material using an acidic catalyst, and a saturated hydrocarbon resin obtained by hydrogenating the unsaturated hydrocarbon resin. Among them, an alicyclic saturated hydrocarbon resin obtained by polymerizing mainly the C9 fraction to produce an aromatic petroleum resin and further hydrogenating it is preferable from the viewpoint of compatibility with the crystalline polypropylene resin and imparting transparency and flexibility to the thermoplastic resin film. Such an alicyclic saturated hydrocarbon resin to be used may be a commercially available product. Examples of the commercially available product include the trade name “ARKON” manufactured by ARAKAWA CHEMICAL INDUSTRIES, LTD., the trade name “CLEARON” manufactured by YASUHARA CHEMICAL CO., LTD., the trade name “T-REZ” manufactured by TonenGeneral Sekiyu KK, the trade name “IMARV” manufactured by Idemitsu Kosan Co., Ltd., and the trade name “Oppera” manufactured by Exxon Mobil Corporation.

As described above, the amount of the petroleum resin in the substrate layer (I) is 0.5 to 40% by mass relative to 100% by mass of the total amount of the substrate layer (I). The amount of the petroleum resin is preferably increased from the viewpoint of imparting transparency and flexibility to the thermoplastic resin film, whereas it is preferably decreased from the viewpoint of imparting mechanical strength and good productivity to the thermoplastic resin film. Therefore, the amount of the petroleum resin in the substrate layer (I) is preferably 1% by mass or more and more preferably 5% by mass or more. On the other hand, the amount of the petroleum resin in the substrate layer (I) is preferably 35% by mass or less, more preferably 30% by mass or less and further preferably 10% by mass or less. Thus, the amount of the petroleum resin in the substrate layer (I) is preferably 1 to 35% by mass, more preferably 5 to 30% by mass and further preferably 5 to 10% by mass.

The resin film constituting the substrate layer (I) preferably further includes a nucleating agent. Inclusion of the nucleating agent in the substrate layer (I) makes it possible to avoid macrocrystallization of the crystalline portion in the crystalline polypropylene resin and to thereby promote microcrystallization even though the thermoplastic resin film is an unstretched film as described later and is under relatively slow cooling conditions. This can decrease the internal haze of the substrate layer (I) and increase the transparency and flexibility of the thermoplastic resin film.

Examples of the nucleating agent that can be used in the present invention include benzylidene sorbitols, metal salts of benzoic acid and metal salts of phosphoric acid esters. Specific examples of the benzylidene sorbitols include dibenzylidene sorbitol, 1,3 or 2,4-dibenzylidene sorbitol, dimethyldibenzylidene sorbitol, 1,3 or 2,4-bis(dimethylbenzylidene)sorbitol, p-ethylbenzylidene sorbitol, bis(p-methylbenzylidene)sorbitol and bis(p-ethylbenzylidene)sorbitol. Examples of the metal salts of benzoic acid include aluminum benzoate, aluminum p-t-butylbenzoate, aluminum di(p-t-butylbenzoate), hydroxyaluminum p-t-butylbenzoate, hydroxyaluminum di(p-t-butylbenzoate), sodium benzoate, sodium β-naphthalate, sodium cyclohexanecarboxylate, potassium benzoate, lithium benzoate and a metal salt of rosin. Examples of the metal salts of phosphoric acid ester include sodium bis(4-t-butylphenyl)phosphate, sodium 2,2′-methylenebis(4,6-di-t-butylphenyl)phosphate and aluminum 2,2′-methylenebis(4,6-di-t-butylphenyl)phosphate. These nucleating agents may be used alone or in combinations of two or more.

The amount of the nucleating agent is preferably 0.01 parts by mass or more and more preferably 0.05 parts by mass or more relative to 100 parts by mass of the crystalline polypropylene resin. Also, the amount of the nucleating agent is preferably 1 part by mass or less and more preferably 0.5 parts by mass or less relative to 100 parts by mass of the crystalline polypropylene resin. The amount of the nucleating agent is preferably increased from the viewpoint of imparting transparency and flexibility, and is preferably decreased from the viewpoint of reducing cost and inhibiting a decrease in transparency of the substrate layer (I). Among them, the amount of the nucleating agent is preferably 0.01 to 1 part by mass and more preferably 0.05 to 0.5 parts by mass relative to 100 parts by mass of the crystalline polypropylene resin. The amount of the nucleating agent in such a range easily provides a thermoplastic resin film having high transparency and high flexibility at low cost.

The substrate layer (I) may contain, as necessary, an additive such as an antioxidant, an ultraviolet stabilizer, a lubricant, a compatibilizer, a flame retardant or a coloring pigment. When the substrate layer (I) contains an antioxidant, the amount of the antioxidant is preferably 0.001 to 1% by mass relative to 100% by mass of the total amount of the substrate layer (I). Specific examples of the antioxidant include a sterically hindered phenol-based stabilizer, a phosphorus-based stabilizer and an amine-based stabilizer. When the substrate layer (I) contains an ultraviolet stabilizer, the amount of the ultraviolet stabilizer is preferably 0.001 to 1% by mass relative to 100% by mass of the total amount of the substrate layer (I). Specific examples of the ultraviolet stabilizer include a sterically hindered amine-based light stabilizer, a benzotriazole-based light stabilizer and a benzophenone-based light stabilizer.

The thickness of the substrate layer (I) is preferably 20 μm or more, more preferably 30 μm or more and further preferably 40 μm or more. On the other hand, the thickness of the substrate layer (I) is preferably 200 μm or less, more preferably 100 m or less and further preferably 80 μm or less. The thick substrate layer (I) tends to easily increase the mechanical strength as a label substrate, whereas the thin substrate layer (I) tends to easily increase the flexibility as a label substrate. Therefore, the thickness of the substrate layer (I) is preferably 20 to 200 μm, more preferably 30 to 100 m and further preferably 40 to 80 μm.

### [Printable Layer (II)]

The printable layer (II) constituting the thermoplastic resin film of the present invention is a layer located on the one surface of the thermoplastic resin film and is a layer capable of being printed thereon when the thermoplastic resin film is used as an adhesive label. From the viewpoint of printability, the printable layer (II) is preferably a layer comprising a polypropylene resin and a polyethylene resin as a thermoplastic resin.

Examples of the polypropylene resin that can be used for the printable layer (II) include resins described above as a crystalline polypropylene resin used for the substrate layer (I) as well as a polypropylene resin having a polar group such as maleic anhydride-modified polypropylene.

Examples of the polyethylene resin that can be used for the printable layer (II) include a copolymer of a high-density polyethylene, a medium-density polyethylene, a linear low-density polyethylene or ethylene as a main component with an α-olefin such as propylene, butene, hexene, heptene, octene or 4-methylpentene-1; an ethylene-vinyl acetate copolymer, an ethylene-acrylic acid copolymer, an ethylene-alkyl acrylate copolymer, an ethylene-alkyl methacrylate copolymer, a metal salt of an ethylene-methacrylic acid copolymer (the metal is zinc, aluminum, lithium, sodium, potassium or the like), an ethylene-cyclic olefin copolymer, a maleic anhydride-modified polyethylene and a maleic anhydride-modified ethylene-vinyl acetate copolymer. Among them, the thermoplastic resin having a polar group in its molecule is preferably comprised from the viewpoint of improving the adhesion thereof with an ink used for printing. Specific examples of the thermoplastic resin having a polar group in its molecule include a polyethylene resin such as an ethylene-vinyl acetate copolymer, an ethylene-acrylic acid copolymer, an ethylene-alkyl acrylate copolymer, an ethylene-alkyl methacrylate copolymer or a metal salt of an ethylene-methacrylic acid copolymer; a maleic anhydride-modified polyethylene and a maleic anhydride-modified ethylene-vinyl acetate copolymer.

The amount of the polyethylene resin in the printable layer (II) is preferably 10% by mass or more, more preferably 20% by mass or more, and further preferably 25% by mass or more relative to 100% by mass of the total amount of the composition comprising the polypropylene resin and the polyethylene resin. On the other hand, the amount of the polyethylene resin in the printable layer (II) is preferably 60% by mass or less, more preferably 50% by mass or less and further preferably 45% by mass or less relative to 100% by mass of the total amount of the composition comprising the polypropylene resin and the polyethylene resin. The amount of the polyethylene resin is preferably high from the viewpoint of improving the adhesion thereof with an ink used for printing, and is preferably low from the viewpoint of maintaining the transparency of the thermoplastic resin film. Therefore, the amount of the polyethylene resin in the printable layer (II) is preferably 10 to 60% by mass, more preferably 20 to 50% by mass and further preferably 25 to 45% by mass relative to 100% by mass of the total amount of the composition comprising the polypropylene resin and the polyethylene resin.

The printable layer (II) can contain, as necessary, a resin additive such as an antioxidant, an ultraviolet stabilizer, a lubricant, a compatibilizer, a flame retardant or a coloring pigment as described for the substrate layer (I), similarly.

The thickness of the printable layer (II) is preferably 1 μm or more and more preferably 5 μm or more. On the other hand, the thickness of the printable layer (II) is preferably 30 μm or less and more preferably 20 μm or less. The thick printable layer (II) tends to be easily improved in the adhesion thereof with an ink, whereas the thin printable layer (II) tends to easily inhibit the thermoplastic resin film from curling. Thus, the thickness of the printable layer (II) is preferably 1 to 30 μm and more preferably 5 to 20 μm.

The surface of the printable layer (II) is preferably roughened, from the viewpoint of improving the visibility of an indication such as characters to be printed. Specifically, it is preferable that the surface of the printable layer (II) side of the thermoplastic resin film has an arithmetic mean roughness (Ra) of 0.15 to 2 μm and a ten-point mean roughness (Rzjis) of 0.5 to 6 μm. Roughening the surface of the printable layer (II) as described above easily improves the adhesion of the printable layer (II) with an ink used for printing due to the anchor effect. In addition, roughening can further increase the matting effect, further improving the indication visibility.

The surface of the printable layer (II) can be roughened by the same method as the adhesive-processing layer (III) described later.

### [Adhesive-Processing Layer (III)]

The adhesive-processing layer (III) constituting the thermoplastic resin film of the present invention is a layer located on the other surface of the thermoplastic resin film and is a layer to be provided with an adhesive layer (IV) thereon when the thermoplastic resin film is used as an adhesive label. Providing the substrate layer (I) with the adhesive-processing layer (III) can impart a mat feeling to the thermoplastic resin film. The mat feeling can increase the visibility of an indication such as characters without impairing high transparency of the substrate layer (I) and can further impart a high-grade feeling such that the indication such as characters emerges. In addition, the adhesive-processing layer (III) can increase the adhesion with an adhesive and thereby provide an adhesive label having a high interlaminar strength with the adhesive layer (IV) described later.

In the present invention, the adhesive-processing layer (III) is preferably a layer comprising a linear low-density polyethylene resin as a main component. Specifically, the adhesive-processing layer (III) preferably includes 50% by mass or more of a linear low-density polyethylene resin. Inclusion of 50% by mass or more of the linear low-density polyethylene resin in the adhesive-processing layer (III) increases the adhesion to the substrate layer (I) and thereby easily improves the interlaminar strength, and easily imparts a mat feeling. For this reason, the thermoplastic resin film comprising, as a substrate layer (I), a resin film of a crystalline polypropylene resin having a petroleum resin compounded thereinto and further comprising an adhesive-processing layer (III) comprising a linear low-density polyethylene as a main component is excellent in transparency and indication visibility and further improves the adhesion with an adhesive. Therefore, it can be particularly suitably used for an adhesive label.

Examples of the linear low-density polyethylene resin to be used in the present invention include preferably a linear low-density polyethylene having a density of 0.857 to 0.940 g/cm³ and more preferably a linear low-density polyethylene having a crystallinity (X-ray method) of 10 to 60% and a number average molecular weight of 10,000 to 40,000.

The resin film constituting the adhesive-processing layer (III) can contain a known anti-blocking agent. This can improve the ease in handling the thermoplastic resin film. The adhesive-processing layer (III) preferably contains an anti-blocking agent in the range of 0.05 to 5 parts by mass and more preferably in the range of 0.1 to 1 part by mass relative to 100 parts by mass of the linear low-density polyethylene resin.

The resin film constituting the adhesive-processing layer (III) can further contain, as necessary, a resin additive such as an antioxidant, an ultraviolet stabilizer, a lubricant, a compatibilizer, a flame retardant or a coloring pigment as described for the substrate layer (I), similarly.

The surface of the adhesive-processing layer (III) opposite to the substrate layer (I) is preferably roughened, from the viewpoint of improving the visibility of a printed indication. Specifically, the arithmetic mean roughness (Ra) of the surface of the adhesive-processing layer (III) of the thermoplastic resin film is preferably 0.5 μm or more and more preferably 1 μm or more. On the other hand, the arithmetic mean roughness (Ra) of the surface of the adhesive-processing layer (III) of the thermoplastic resin film is preferably 5 μm or less and more preferably 3 μm or less. The high arithmetic mean roughness (Ra) value further imparts a mat feeling and thereby easily improves the visibility of a printed indication, whereas the low value easily provides the transparency of entire thermoplastic resin film. In addition, the ten-point mean roughness (Rzjis) of the surface of the adhesive-processing layer (III) of the thermoplastic resin film is preferably 10 μm or more and more preferably 12 μm or more. On the other hand, the ten-point mean roughness (Rzjis) of the surface of the adhesive-processing layer (III) of the thermoplastic resin film is preferably 50 μm or less and more preferably 25 μm or less. Among them, it is preferable that the arithmetic mean roughness (Ra) is 0.5 to 5 μm and the ten-point mean roughness (Rzjis) is 10 to 50 μm. The arithmetic mean roughness (Ra) is more preferably 1 to 3 μm. The ten-point mean roughness (Rzjis) is more preferably 12 to 25 μm. Roughening the surface of the adhesive-processing layer (III) as described above causes the anchor effect to improve the adhesion between the adhesive-processing layer (III) and the substrate layer (I), and easily provides a thermoplastic resin film having an excellent interlaminar strength. Roughening can further impart a mat feeling and thereby further increase the visibility of printed indication on an adhesive label having an adhesive layer (IV) provided on the surface of the adhesive-processing layer (III).

Examples of the process for roughening the surface of the adhesive-processing layer (III) as described above include: a process for roughening the surface by extruding a resin composition constituting the adhesive-processing layer (III) from dies and transferring a satin pattern or an embossed pattern provided on the surface of a casting roll to the adhesive-processing layer (III) while cooling into a film shape by a cast roll to form a film; a process for roughening the surface by using an elastic roll as a touch roll for a nip pressure and transferring the roughness of the surface of the roll; and a process for roughening the surface by rapidly air-cooling the surface of a casted film using an air nozzle, air chamber or the like. The surface of an extruded sheet after casting and cooling may also be reheated and then roughened by pressure pressing an embossing roll or a satin roll against it.

The thickness of the adhesive-processing layer (III) is preferably 1 μm or more and more preferably 5 μm or more. On the other hand, the thickness of the adhesive-processing layer (III) is preferably 30 μm or less and more preferably 20 μm or less. The thick adhesive-processing layer (III) tends to easily impart the surface roughness of interest, whereas the thin adhesive-processing layer (III) tends to easily inhibit the thermoplastic resin film from curling. Thus, the thickness of the adhesive-processing layer (III) is preferably 1 to 30 pin and more preferably 5 to 20 μm.

### [Forming Thermoplastic Resin Film]

Regarding the process for forming the thermoplastic resin film of the present invention, the thermoplastic resin film can be produced by combining various forming processes known to those skilled in the art. The resin film produced by any process is included within the scope of the present invention, as long as the thermoplastic resin film satisfying the conditions described in the prevent invention is used in the process.

The process for blending the components of each layer constituting the thermoplastic resin film of the present invention may be any one of various blending processes known to those skilled in the art, and it is not particularly limited. Conditions such as the blending temperature and the blending time can also be appropriately selected depending on the properties of components to be used and the like. Specific examples of the blending process include a melt kneading process in which components such as a thermoplastic resin and additives in the form of powder or pellet are blended using a Henschel mixer, a ribbon blender, a super mixer or the like and then melt kneaded in a single screw extruder or a twin screw kneading extruder. The components are easy to handle in the forming step, if the melt-kneaded material is then pelletized by: a process of extruding the melt-kneaded material into strands and cutting them; a process of extruding the melt-kneaded material into water from a strand die and cutting the resulting strands with a rotary blade attached to the tip of the die; or the other processes.

The process for forming each layer constituting the thermoplastic resin film of the present invention may be known various film production techniques and a combination thereof. Examples of the forming process include: a cast forming process of extruding a molten resin into a sheet shape using a single-layer T-die connected to a screw extruder; a multilayer cast forming process in which a multilayer T-die connected to a plurality of screw extruders is used and molten resins are laminated in the die and extruded into a sheet shape and; an inflation forming process of extruding a molten resin into a tubular shape using O-die connected to a screw extruder; a melt extrusion lamination process of extruding a molten resin into a sheet shape using a T-die connected to a screw extruder; rolling process; and calendering process. These may be used in combination. Among them, the multilayer cast forming process is preferable.

The thermoplastic resin film of the present invention may be a film stretched in at least uniaxial direction after formed into a sheet shape, but each of the substrate layer (I), the printable layer (II) and the adhesive-processing layer (III) is preferably composed of an unstretched resin film. When each layer is an unstretched film, it is easy to avoid decreases in transparency and flexibility occurring with crystallization caused by stretch orientation of a crystalline polypropylene resin or the like.

It is preferable in the thermoplastic resin film of the present invention that the surfaces of the printable layer (II) and the adhesive-processing layer (III) are activated by as necessary subjecting them to activation treatment. By subjecting the surface of the printable layer (II) to activation treatment, the adhesion thereof with an ink is increased and the printability of the surface is easily improved. In addition, by subjecting the surface of the adhesive-processing layer (III) to activation treatment, wettability with an adhesive is improved and the adhesion between the thermoplastic resin film and the adhesive layer (IV) can be improved when the thermoplastic resin film is used as an adhesive label.

Examples of the activation treatment include at least one treatment process selected from corona discharge treatment, flame treatment, plasma treatment, glow discharge treatment and ozone treatment. Corona treatment or frame treatment is preferred. In the case of corona treatment, the throughput is usually 600 J/m² (10 W·min/m²) or more and preferably 1200 J/m² (20 W·min/m²) or more. On the other hand, the throughput is usually 12,000 J/m² (200 W·min/m²) or less and preferably 9000 J/m² (150 W·min/m²) or less. The higher throughput can provide the effect of the corona discharge treatment more sufficiently, and the subsequent printing and adhesive processing can be more suitably performed. Also, the throughput may be low from the viewpoint of efficiently providing an appropriate effect. Accordingly, the throughput is usually 600 to 12,000 J/m² (10 to 200 W·min/m²) and preferably 1200 to 9000 J/m² (20 to 150 W·min/m²). However, in the case of frame treatment, the throughput is usually 8,000 J/m² or more and preferably 20,000 J/m² or more. On the other hand, the throughput is usually 200,000 J/m² or less and preferably 100,000 J/m² or less. The higher throughput can provide the effect of the flame treatment more sufficiently, and the subsequent printing and adhesive processing can be more suitably performed. Also, the throughput may be low from the viewpoint of efficiently providing an appropriate effect. Accordingly, the throughput is usually 8,000 to 200,000 J/m² and preferably 20,000 to 100,000 J/m².

In the thermoplastic resin film of the present invention, assuming that the thickness of the substrate layer (I) is 100%, the thickness of each of the printable layer (II) and the adhesive-processing layer (III) is preferably 10 to 35% relative to 100% of the thickness of the substrate layer (I). When the substrate layer (I) is relatively thicker than the other layers, the thermoplastic resin film is excellent in mechanical strength, whereas when it is relatively thinner, the thermoplastic resin film is excellent in flexibility and transparency. On the other hand, when the printable layer (II) or the adhesive-processing layer (III) is relatively thicker than the other layers, the effect of the activation treatment is easily exerted, whereas when it is relatively thinner, the thermoplastic resin film is excellent in processability such as punching.

### [Adhesive Label]

An adhesive label (pressure-sensitive adhesive label) of the present invention is a label further comprising an adhesive layer (IV) provided on the surface of the adhesive-processing layer (III) side of the thermoplastic resin film of the present invention described above.

### [Adhesive Layer (IV)]

Examples of the adhesive (pressure-sensitive adhesive) used in the adhesive layer (pressure-sensitive adhesive layer) (IV) include a rubber adhesive, an acrylic adhesive and a silicone adhesive. Specific examples of the rubber adhesive include a composition having polyisobutylene rubber, butyl rubber or a mixture thereof dissolved in an organic solvent such as benzene, toluene, xylene or hexane; or a composition having a tackifier such as abietic acid rosin ester, a terpene-phenol copolymer or a terpene-indene copolymer compounded into the rubber adhesive. Specific examples of the acrylic adhesive which can be used include a composition having an acrylic-based copolymer having a glass transition point of −20° C. or less such as a 2-ethylhexyl acrylate-n-butyl acrylate copolymer, a 2-ethylhexyl acrylate-ethyl acrylate-methyl methacrylate copolymer dissolved in an organic solvent; or an emulsion-type adhesive comprising an acrylic-based copolymer having the same composition. Among them, an acrylic adhesive is preferable from the viewpoint of transparency. The adhesive to be used can be in various forms such as a solution type, an emulsion type, a delayed type and a hot melt type. Among them, the solution type or emulsion type is preferable and the solution type is more preferable from the viewpoint of ease of forming.

The adhesive layer (IV) may be formed by directly coating the surface of the adhesive-processing layer (III) side of the thermoplastic resin film with the above adhesive and as necessary drying it. Alternatively, the adhesive layer (IV) may be obtained by coating the release paper described later with the above adhesive and as necessary drying to form an adhesive layer (IV), and then laminating the adhesive layer (IV) on the thermoplastic resin film so as to be in contact with the surface of the adhesive-processing layer (III) side of the thermoplastic resin film. The latter process of obtaining the adhesive layer (IV) by forming the adhesive layer (IV) and then laminating the adhesive layer (IV) is more preferable because each of the layers (I) to (III) of the thermoplastic resin film is not placed under a high temperature during drying of the adhesive layer.

Examples of the device for applying the adhesive can include a die coater, a bar coater, a comma coater, a lip coater, a roll coater, a gravure coater, a spray coater, a blade coater, a reverse coater, and an air knife coater. The adhesive is applied by such a coating device followed by as necessary levelling, smoothing and drying to form an adhesive layer (IV). Among them, a comma coater or a gravure coater is preferable and a gravure coater is more preferable, from the viewpoint of coatability.

The coating amount of the adhesive is not particularly limited but is usually 3 to 60 g/m², preferably 5 to 40 g/m² and more preferably 10 to 30 g/m² in terms of the solid content after drying.

The thickness of the adhesive layer (IV) is preferably 10 to 50 μm in the case of an acrylic adhesive and is preferably 80 to 150 μm in the case of a rubber adhesive.

### [Release Paper]

The adhesive label of the present invention can also comprise a release paper on the outermost surface of the adhesive layer (IV), as necessary, in order to facilitate handling prior to affixing the label to an adherend.

The release paper may be any sheet-shaped release paper having a lower adhesion force between it and the adhesive layer (IV) than the adhesion force between the adhesive-processing layer (III) and the adhesive layer (IV), and any release paper can be appropriately selected from conventional release papers and used. Examples of the release paper include a pulp paper such as a high-quality paper and a kraft paper; a processed paper obtained by calendaring the pulp paper; a processed paper having the pulp paper coated or impregnated with a resin, a processed paper having a resin film laminated on the pulp paper, a glassine paper; a coated paper; and a processed paper having a plastic film or the like siliconized. A processed paper obtained by siliconizing the surface in contact with the adhesive layer (IV) is suitably used as a release paper, from the viewpoint of adjusting the releasability from the adhesive layer (IV).

### [Printing]

The surface of the printable layer (II) side of a thermoplastic resin film and an adhesive label of the present invention can be subjected to letter printing, gravure printing, offset printing, flexographic printing, screen printing and the like. By these printing processes, various types of information can be indicated such as a product name, a product number, a product size, product materials, a barcode, a manufacturer, a dealer name, a character name, or directions for use. In addition, various information can be indicated on the surface of the printable layer (II) side substantially in the same manner as printing even by a process other than so-called printing, for example, with a writing instrument such as a pencil or pen. The printed thermoplastic resin film and adhesive label can be separated into pieces having the desired shape and size by punching or slit processing, and is wound around a commercial product, pasted or the like.

### EXAMPLES

Hereinafter, the present invention will be described more specifically by way of production examples, working examples and test examples. Materials, used amount, proportion, treatment contents, treatment procedures and the like shown in the following examples can be appropriately changed without departing from the spirit of the present invention. Therefore, the technical scope of the present invention is not limited by the following specific examples and the like.

Measurement methods and evaluation methods of physical properties in production examples, Examples and Comparative Examples were carried out in such a way as described below.

### (1) Thickness

The overall thickness of a thermoplastic resin film was measured using a micrometer (trade name: PG-01J, manufactured by TECLOCK Corporation) according to JIS-P 8118. The thickness of each layer constituting the thermoplastic resin film was measured as follows. The thermoplastic resin film was cooled with liquid nitrogen to a temperature of −60° C. or less, and the sample placed on a glass plate was cut with a razor blade perpendicularly applied to the film to prepare a sample for cross-section measurement. The cross-section of the prepared sample was observed with a scanning electron microscope, and the boundary lines between layers were determined from the composition and appearance to determine the thickness ratio of each layer in the thermoplastic resin film. Next, the thickness of each layer was calculated by multiplying the overall thickness of the thermoplastic resin film by the thickness ratio of each layer in the thermoplastic resin film.

### (2) Internal Haze

The internal haze was measured using a haze meter (trade name: NDH 2000, manufactured by NIPPON DENSHOKU INDUSTRIES CO., LTD.) according to JIS-K 7136. Specifically, the front and back surfaces of the sample were filled with liquid paraffin (for infrared analysis; manufactured by Wako Pure Chemical Industries, Ltd.) to wet the measurement area, and the sample was sandwiched between two slide glasses (Preclean Water Edge Grinding, manufactured by Matsunami Glass Ind., Ltd.; thickness: 0.9 to 1.2 mm) and was measured for the internal haze.

### (3) Surface Roughness

The arithmetic mean roughness (Ra) and the ten-point mean roughness (Rzjis) were measured with a surface roughness/contour shape measuring instrument (trade name: SURFCORDER SE-30, manufactured by Kosaka Laboratory Ltd.) according to JIS-B 0601: 2001.

### (4) Transparency

The thermoplastic resin film obtained from each of Examples and Comparative Examples was shaped into a continuous roll of 800 mm in width, and arbitrary sequence of characters with a font size of 20 points was printed on the surface of the printable layer (II) side of the thermoplastic resin film with black gravure ink by gravure printing. The thermoplastic resin film after printing was cut to a size of 100 mm in width×100 mm in length to prepare a sample. The sample was placed on black-based clothing, and the evaluation as to whether transparency is good or poor was made according to the following criteria:

B: the texture of the clothing (pattern of the textile) is visible through the sample; and

D: the texture of the clothing (pattern of the textile) is not visible through the sample.

### (5) Indication Visibility

The sample used in the evaluation on transparency was evaluated on the visibility of the printed sequence of characters according to the following criteria:

A: the printed sequence of characters can be easily read; and

B: the printed sequence of characters can be read but not easily.

### Example 1

Using a multilayer cast forming process, in which a multilayer T-die connected to a plurality of screw extruders is used and molten resins are laminated in the die and extruded into a sheet shape, a co-extruded unstretched sheet composed of three layers of three different types was obtained and thereby a thermoplastic resin film of Example 1 was obtained.

Specifically, a semimirror-tone metal chill roll was used as a cooling roll at the time of cast forming. The semimirror-tone metal chill roll was obtained by processing the surface of mirror-finished metal chill roll, which had been subjected to hard chrome plating, into a semimat tone and then further polishing it. As measured for the surface of this roll according to JIS-B 0601: 2001, the arithmetic mean roughness (Ra) was 0.3 μm, the maximum height (Rz) was 2.9 μm, and the ten-point mean roughness (Rzjis) was 2.2 μm. This roll was 450 mm in diameter and 1500 mm in width. In addition, a mat-tone rubber roll having a rubber hardness of 70, containing sand of #500 mesh and having a diameter of 300 mm and a width of 1500 mm was used as a rubber roll nipping together with the cooling roll.

The resin compositions of the three layers are as follows. A composition of 100 parts by mass of a mixture of 99% by mass of a crystalline polypropylene resin PP and 1% by mass of a petroleum resin PR shown in Table 1 having 0.198 parts by mass of a nucleating agent NA compounded therewith (that is, a mixture having 95.898 parts by mass of the crystalline polypropylene resin PP, 1 part by mass of the petroleum resin PR and 3.3 parts by mass of the nucleating agent NA compounded so as to contain 0.2 parts by mass of the nucleating agent relative to 100 parts by mass of the crystalline polypropylene resin) was used for the substrate layer (I) A composition of 60% by mass of a crystalline polypropylene resin PP and 40% by mass of a polyethylene resin LDPE shown in Table 1 was used for the printable layer (II). 100% by mass of a linear low-density polyethylene resin LLDPE shown in Table 1 was used for the adhesive-processing layer (III).

Each of the resin compositions of these three layers was melt-kneaded at 240° C. with a separate extruder, and then fed to a set of co-extrusion T-dies and the three layers were laminated in the T-die. Then, the laminate was extruded into a sheet shape through the T dies and the sheet was fed between the semimirror-tone metal chill roll and the mat-tone rubber roll so that the printable layer (II) was in contact with the semimirror-tone metal chill roll and the adhesive-processing layer (III) was in contact with the mat-tone rubber roll. Cooling while nipping (line pressure of about 1.5 kg/cm) between the rolls provided a thermoplastic resin film of Example 1.

The resulting thermoplastic resin film was fed to a corona discharge treatment device with a guide roll while taking off the thermoplastic resin film with a winder; both surfaces of the printable layer (II) and adhesive-processing layer (III) of the thermoplastic resin film were subjected to corona discharge treatment at a throughput of 50 w·min/m²; and the thermoplastic resin film was then wound up by the winder.

The thickness of the thermoplastic resin film of Example 1 was 75 μm (10 μm for the printable layer (II), 55 μm for the substrate layer (I) and 10 μm for the adhesive-processing layer (III)). In Example 1, the internal haze value was 9%, the arithmetic mean roughness (Ra) and the ten-point mean roughness (Rzjis) of the surface of the adhesive-processing layer (III) were 1.8 μm and 17 μm, respectively, and the arithmetic mean roughness (Ra) and the ten-point mean roughness (Rzjis) of the surface of the printable layer (II) were 0.3 μm and 2 μm, respectively.

### Example 2

The thermoplastic resin film of Example 2 was obtained by obtaining a co-extruded unstretched sheet composed of three layers of three different types in the same manner as in Example 1, except that the rubber roll and the resin compositions of the three layers used in Example 1 were changed as follows.

Specifically, a mat-tone rubber roll having a rubber hardness of 70, containing sand of #600 mesh and having a diameter of 300 mm and a width of 1500 mm was used as a rubber roll.

The resin compositions of the three layers are as follows. A composition of 100 parts by mass of a mixture of 95% by mass of a crystalline polypropylene resin PP and 5% by mass of a petroleum resin PR shown in Table 1 having 0.19 parts by mass of a nucleating agent NA compounded therewith (so as to contain 0.2 parts by mass of the nucleating agent relative to 100 parts by mass of the crystalline polypropylene resin) was used for the substrate layer (I). A composition of 70% by mass of a crystalline polypropylene resin PP and 30% by mass of a polyethylene resin EVA shown in Table 1 was used for the printable layer (II). A composition having 100 parts by mass of a linear low-density polyethylene resin LLDPE shown in Table 1 compounded with 0.5 parts by mass of an anti-blocking agent AB was used for the adhesive-processing layer (III).

The thickness of the thermoplastic resin film of Example 2 was 75 μm (10 μm for the printable layer (II), 55 μm for the substrate layer (I) and 10 μm for the adhesive-processing layer (III)). In Example 2, the internal haze value was 10%, the arithmetic mean roughness (Ra) and the ten-point mean roughness (Rzjis) of the surface of the adhesive-processing layer (III) were 1.2 μm and 12 μm, respectively, and the arithmetic mean roughness (Ra) and the ten-point mean roughness (Rzjis) of the surface of the printable layer (II) were 0.3 μm and 3 μm, respectively.

### Example 3

The thermoplastic resin film of Example 3 was obtained by obtaining a co-extruded unstretched sheet composed of three layers of three different types in the same manner as in Example 1, except that the resin compositions of the three layers in Example 1 were changed as follows.

Specifically, the resin compositions of the three layers are as follows. A composition of 100 parts by mass of a mixture of 90% by mass of a crystalline polypropylene resin PP and 10% by mass of a petroleum resin PR shown in Table 1 having 0.09 parts by mass of a nucleating agent NA compounded therewith (so as to contain 0.1 parts by mass of the nucleating agent relative to 100 parts by mass of the crystalline polypropylene resin) was used for the substrate layer (I) A composition of 60% by mass of a crystalline polypropylene resin PP and 40% by mass of a polyethylene resin LDPE shown in Table 1 was used for the printable layer (II). 100% by mass of a linear low-density polyethylene resin LLDPE shown in Table 1 was used for the adhesive-processing layer (III).

The thickness of the thermoplastic resin film of Example 3 was 75 μm (10 μm for the printable layer (II), 55 μm for the substrate layer (I) and 10 μm for the adhesive-processing layer (III)). In Example 3, the internal haze value was 9%, the arithmetic mean roughness (Ra) and the ten-point mean roughness (Rzjis) of the surface of the adhesive-processing layer (III) were 2.1 μm and 16 μm, respectively, and the arithmetic mean roughness (Ra) and the ten-point mean roughness (Rzjis) of the surface of the printable layer (II) were 0.3 μm and 2 μm, respectively.

### Example 4

The thermoplastic resin film of Example 4 was obtained by obtaining a co-extruded unstretched sheet composed of three layers of three different types in the same manner as in Example 1, except that the resin compositions of the three layers in Example 1 were changed as follows.

Specifically, the resin compositions of the three layers are as follows. A composition of was 100 parts by mass of a mixture of 85% by mass of a crystalline polypropylene resin PP and 15% by mass of a petroleum resin PR shown in Table 1 having 0.085 parts by mass of a nucleating agent NA compounded therewith (so as to contain 0.1 parts by mass of the nucleating agent relative to 100 parts by mass of the crystalline polypropylene resin) was used for the substrate layer (I) A composition of 70% by mass of a crystalline polypropylene resin PP and 30% by mass of a polyethylene resin EVA shown in Table 1 was used for the printable layer (II). 100% by mass of a linear low-density polyethylene resin LLDPE shown in Table 1 was used for the adhesive-processing layer (III).

The thickness of thermoplastic resin film of Example 4 was 75 μm (10 μm for the printable layer (II), 55 μm for the substrate layer (I) and 10 μm for the adhesive-processing layer (III)). In Example 4, the internal haze value was 8%, the arithmetic mean roughness (Ra) and the ten-point mean roughness (Rzjis) of the surface of the adhesive-processing layer (III) were 2.2 μm and 16 μm, respectively, and the arithmetic mean roughness (Ra) and the ten-point mean roughness (Rzjis) of the surface of the printable layer (II) were 0.3 μm and 3 μm, respectively.

### Example 5

The thermoplastic resin film of Example 5 was obtained by obtaining a co-extruded unstretched sheet composed of three layers of three different types in the same manner as in Example 1, except that the resin compositions of the three layers in Example 1 were changed as follows.

Specifically, the resin compositions of the three layers are as follows. A composition of 100 parts by mass of a mixture of 70% by mass of a crystalline polypropylene resin PP and 30% by mass of a petroleum resin PR shown in Table 1 having 0.07 parts by mass of a nucleating agent NA compounded therewith (so as to contain 0.1 parts by mass of the nucleating agent relative to 100 parts by mass of the crystalline polypropylene resin) was used for the substrate layer (I) A composition of 60% by mass of a crystalline polypropylene resin PP and 40% by mass of a polyethylene resin LDPE shown in Table 1 was used for the printable layer (II). A composition having 100 parts by mass of a linear low-density polyethylene resin LLDPE shown in Table 1 compounded with 0.5 parts by mass of an anti-blocking agent AB2 was used for the adhesive-processing layer (III).

The thickness of thermoplastic resin film of Example 5 was 75 μm (10 μm for the printable layer (II), 55 μm for the substrate layer (I) and 10 μm for the adhesive-processing layer (III)). In Example 5, the internal haze value was 7%, the arithmetic mean roughness (Ra) and the ten-point mean roughness (Rzjis) of the surface of the adhesive-processing layer (III) were 1.5 μm and 13 μm, respectively, and the arithmetic mean roughness (Ra) and the ten-point mean roughness (Rzjis) of the surface of the printable layer (II) were 0.3 μm and 2 μm, respectively.

### Comparative Example 1

The thermoplastic resin film of Comparative Example 1 was obtained by obtaining a co-extruded unstretched sheet composed of three layers of three different types in the same manner as in Example 1, except that the resin compositions of the substrate layer (I) in Example 1 were changed as follows.

Specifically, 100% by mass of a crystalline polypropylene resin PP shown in Table 1 was used for the substrate layer (I).

The thickness of thermoplastic resin film of Comparative Example 1 was 75 μm (10 μm for the printable layer (II), 55 μm for the substrate layer (I) and 10 μm for the adhesive-processing layer (III)). In Comparative Example 1, the internal haze value was 17%, the arithmetic mean roughness (Ra) and the ten-point mean roughness (Rzjis) of the surface of the adhesive-processing layer (III) were 1.7 μm and 17 μm, respectively, and the arithmetic mean roughness (Ra) and the ten-point mean roughness (Rzjis) of the surface of the printable layer (II) were 0.3 μm and 2 μm, respectively.

### Example 6

The thermoplastic resin film of Example 6 was obtained by obtaining a co-extruded unstretched sheet composed of three layers of three different types in the same manner as in Example 1, except that an air chamber was used instead of the mat-tone rubber roll used as a nip roll in Example 1.

The thickness of thermoplastic resin film of Example 6 was 75 μm (10 μm for the printable layer (II), 55 μm for the substrate layer (I) and 10 μm for the adhesive-processing layer (III)). In Example 6, the internal haze value was 9%, the arithmetic mean roughness (Ra) and the ten-point mean roughness (Rzjis) of the surface of the adhesive-processing layer (III) were 0.9 μm and 4 μm, respectively, and the arithmetic mean roughness (Ra) and the ten-point mean roughness (Rzjis) of the surface of the printable layer (II) were 0.3 μm and 2 μm, respectively.

TABLE 1

| Type | Abbreviation | Details |
|---|---|---|
| Crystalline | PP | Propylene homopolymer (trade name: NOVATEC PP MA3; manufactured by |
| polypropylene resin | | Japan Polypropylene Corporation; MFR (230° C., 2.16 kg load): 11 g/10 min; |
| | | density: 0.90 g/cm³) |
| Petroleum resin | PR | Alicyclic saturated hydrocarbon resin (trade name: ARKON P-140; manufactured |
| | | by ARAKAWA CHEMICAL INDUSTRIES, LTD.; softening point (ring and ball |
| | | method): 140° C.) |
| Polyethylene resin | LDPE | Low-density polyethylene (trade name: NOVATEC LD LC522; manufactured by |
| | | Japan Polyethylene Corporation; MFR (190° C., 2.16 kg load): 4 g/10 min; density: |
| | | 0.92 g/cm³) |
| | EVA | Maleic anhydride-modified ethylene-vinyl acetate copolymer (trade name: Modic |
| | | AP A515; manufactured by Japan Polyethylene Corporation; MFR (190° C., 2.16 kg |
| | | load): 9.5 g/10 min; density: 0.95 g/cm³) |
| Linear low-density | LLDPE | Linear low-density polyethylene (trade name: NOVATEC LL UF240; |
| polyethylene resin | | manufactured by Japan Polyethylene Corporation; MFR (190° C., 2.16 kg load): |
| | | 2.1 g/10 min; density: 0.92 g/cm³) |
| Nucleating agent | NA | Nucleating agent masterbatch for PP (trade name: PPM ST-0024; manufactured |
| | | by Tokyo Printing Ink Mfg. Co., Ltd.; carrier resin: PP; containing 6% by mass of a |
| | | phosphoric ester metal salt as a nucleating agent) |
| Anti-blocking agent | AB | Anti-blocking agent masterbatch for PE (trade name: PEX ABT-12; manufactured |
| | | by Tokyo Printing Ink Mfg. Co., Ltd.; carrier resin: LDPE; containing 20% by mass |
| | | of synthetic zeolite as an anti-blocking agent) |

TABLE 2

| | | | | | | |
|---|---|---|---|---|---|---|
| | | | | | Comparative | |
| Example 1 | Example 2 | Example 3 | Example 4 | Example 5 | Example 1 | Example 6 |

| | | | | | | | | | |
|---|---|---|---|---|---|---|---|---|---|
| Thermoplastic | Printable layer (II) (% by mass) | PP | 60.0 | 70.0 | 60.0 | 70.0 | 60.0 | 60.0 | 60.0 |
| resin film | | LDPE | 40.0 | — | 40.0 | — | 40.0 | 40.0 | 40.0 |
| | | EVA | — | 30.0 | — | 30.0 | — | — | — |
| | Substrate layer (I) (% by mass) | PP | 98.8 | 94.8 | 89.9 | 84.9 | 70.0 | 100.0 | 98.8 |
| | | PR | 1.0 | 5.0 | 10.0 | 15.0 | 30.0 | — | 1.0 |
| | | NA | 0.2 | 0.2 | 0.1 | 0.1 | 0.1 | — | 0.2 |
| | Adhesive-processing layer (III) | LLDPE | 100.0 | 99.5 | 100.0 | 100.0 | 99.5 | 100.0 | 100.0 |
| | (% by mass) | AB | — | 0.5 | — | — | 0.5 | — | — |

| | | | | | | | | | |
|---|---|---|---|---|---|---|---|---|---|
| Evaluation | All layers | Thickness (μm) | 75 | 75 | 75 | 75 | 75 | 75 | 75 |
| of physical | | Internal haze (%) | 9 | 10 | 9 | 8 | 7 | 17 | 9 |
| properties | Adhesive- | Arithmetic mean | 1.8 | 1.2 | 2.1 | 2.2 | 1.5 | 1.7 | 0.9 |
| | processing | roughness (Ra) (μm) | | | | | | | |
| | layer (III) | Ten-point mean | 17 | 12 | 16 | 16 | 13 | 17 | 4 |
| | | roughness (Rzjis) (μm) | | | | | | | |
| | Printable | Arithmetic mean | 0.3 | 0.3 | 0.3 | 0.3 | 0.3 | 0.3 | 0.3 |
| | layer (II) | roughness (Ra) (μm) | | | | | | | |
| | | Ten-point mean | 2 | 3 | 2 | 3 | 2 | 2 | 2 |
| | | roughness (Rzjis) (μm) | | | | | | | |

| | | | | | | | | |
|---|---|---|---|---|---|---|---|---|
| Evaluation of | Transparency | B | B | B | B | B | D | B |
| performances | Indication visibility | A | A | A | A | A | A | B |

Each of the thermoplastic resin films of Examples 1, 2 and 6 and Comparative Example 1 was used to obtain an adhesive label as follows.

The release surface of a silicone-coated release paper was coated with an acrylic adhesive (SK Dyne, manufactured by Soken Chemical & Engineering Co., Ltd.) at a thickness of 25 μm with a gravure coater to form an adhesive layer with a release paper.

The thermoplastic resin film was overlaid on and affixed to the exposed surface of the formed adhesive layer with a release paper to obtain an adhesive label.

The obtained adhesive label was subjected to the following evaluations.

### (6) Transparency and Visibility

A white paper having the black characters “Adhesive Label” (font size: 18 point; font: Times New Roman) printed thereon was provided. After visually observing the characters on this white paper at a position 50 cm apart therefrom, the release paper was peeled off from the adhesive label and the adhesive label was affixed to the white paper so that the adhesive label was overlaid on the characters. Then, the characters were visually observed at the same position again. The transparency and the indication visibility of the adhesive label were evaluated based on the results of visual observation according to the following criteria.

B: the characters can be read irrespective of the presence or absence of the adhesive label, and the transparency and visibility are therefore good.

D: the characters cannot be read in the presence of the adhesive label, and the transparency and visibility are therefore low.

(7) Adhesion with Adhesive

The adhesive label was aged under an atmosphere at a temperature of 23° C. and a relative humidity of 50% RH for 7 days. Then, the release paper was peeled off, and the adhesive label having the adhesive layer exposed was affixed to the surface of a SUS plate and was left to stand for 24 hours. After standing, a measurement sample for measuring the adhesive strength of the adhesive layer was prepared according to JIS Z0237. The resulting measurement sample was peeled off at a peeling rate of 300 mm/min in the direction of 1800 with a tensile tester. The SUS plate after the measurement was visually observed and evaluated according to the following criteria.

A: The area of the SUS plate having the adhesive label peeled off has no adhesive left, and the adhesion is therefore high.

B: The area of the SUS plate having the adhesive label peeled off has a small amount of the adhesive left, indicating the adhesion.

Table 3 below shows the results of evaluations.

TABLE 3

| | | Exam- | Exam- | Comparative | Exam- |
|---|---|---|---|---|---|
| | | ple 1 | ple 2 | Example 1 | ple 6 |
| Evaluations | Transparency | B | B | D | B |
| of adhesive | and visibility | | | | |
| label | Adhesion of | A | A | A | B |
| | adhesive | | | | |

As described above, each of the thermoplastic resin films of Examples 1 to 6 has not only an internal haze of less than 15%, that is, high transparency, but also excellent indication visibility. Examples 1, 2 and 6 show that, even when used as an adhesive label, high transparency and visibility are obtained. It is also shown that since the thermoplastic resin films of Examples 1, 2 and 6 are excellent in interlaminar strength and thus high in adhesion with an adhesive when used as the adhesive label, they can be suitably used as a label.

By contrast, the thermoplastic resin film of Comparative Example 1 having an internal haze of 15% or more is good in indication visibility but poor in transparency, and therefore is poor in transparency and visibility when used in an adhesive label.

The present application claims priority to Japanese Patent Application No. 2017-14138 filed on Jan. 30, 2017, the contents of which are incorporated herein by reference in its entirety.

### INDUSTRIAL APPLICABILITY

The thermoplastic resin film of the present invention combines excellent transparency and visibility of a printed indication. Therefore, it is possible to see a hue, a pattern, a texture, or the like of a commercial product such as clothing through the thermoplastic resin film and the adhesive label including the thermoplastic resin film and at the same time to recognize information indicated by printing therethrough. Therefore, the thermoplastic resin film and the adhesive label of the present invention can be suitably used as indication labels, tags and the like for packaging or clothing.

1. A thermoplastic resin film comprising, in the following order, a printable layer (II), a substrate layer (I) and an adhesive-processing layer (III), wherein
the substrate layer (I) comprises 60 to 99.5% by mass of a crystalline polypropylene resin and 0.5 to 40% by mass of a petroleum resin, and
an internal haze of the thermoplastic resin film is less than 15%.

2. The thermoplastic resin film according to claim 1, wherein the adhesive-processing layer (III) comprises 50% by mass or more of a linear low-density polyethylene resin.

3. The thermoplastic resin film according to claim 1, wherein the substrate layer (I) further comprises a nucleating agent.

4. The thermoplastic resin film according to claim 1, wherein the printable layer (II) comprises a polypropylene resin and a polyethylene resin.

5. The thermoplastic resin film according to claim 1, wherein the substrate layer (I), the printable layer (II) and the adhesive-processing layer (III) each comprise an unstretched resin film.

6. The thermoplastic resin film according to claim 1, wherein the thickness of each of the printable layer (II) and the adhesive-processing layer (III) is 10 to 35% relative to 100% of the thickness of the substrate layer (I).

7. The thermoplastic resin film according to claim 1, wherein the surface on the adhesive-processing layer (III) side of the thermoplastic resin film has an arithmetic mean roughness (Ra) of 0.5 to 5 μm and a ten-point mean roughness (Rzjis) of 10 to 50 μm.

8. The thermoplastic resin film according to claim 1, wherein the surface on the printable layer (II) side of the thermoplastic resin film has an arithmetic mean roughness (Ra) of 0.15 to 2 μm and a ten-point mean roughness (Rzjis) of 0.5 to 6 μm.

9. An adhesive label comprising,
the thermoplastic resin film according to claim 1, and
an adhesive layer (IV) provided on the surface of the adhesive-processing layer (III) side of the thermoplastic resin film.
